(19) United States
(12) Patent Application Publication
(10) Pub. No.: US 2013/0055326 A1
(43) Pub. Date: Feb. 28, 2013

(54) TECHNIQUES FOR DYNAMIC SWITCHING BETWEEN CODED BITSTREAMS

(71) Applicants: Mei-Hsuan Lu, Bellevue, WA (US); Ming-Chieh Lee, Bellevue, WA (US)

(72) Inventors: Mei-Hsuan Lu, Bellevue, WA (US); Ming-Chieh Lee, Bellevue, WA (US)

(73) Assignee: MICROSOFT CORPORATION, Redmond, WA (US)

(21) Appl. No.: 13/221,603

(22) Filed: Aug. 30, 2011

(51) Int. Cl. H04N 7/173

(52) U.S. Cl. 725/109

(57) ABSTRACT

Techniques for dynamic switching in coded bitstreams are described. An apparatus may comprise a switching component operative to determine a timepoint to switch from broadcasting a first video stream to broadcasting a second video stream, the first video stream a first encoding of a video source at a first quality level and the second video stream a second encoding of the video source at a second quality level. Other embodiments are described and claimed.

### BACKGROUND

Ensuring the reliable delivery of digitally transmitted video data has become increasingly important as the use of streaming video has increased. Some applications, such as the live broadcast of an event, necessitate the use of streaming video. Other applications, such as on-demand entertainment, may benefit from the use of streaming instead of downloaded because of the immediacy with which the playback of streaming video can begin. In some applications, a single video source may be encoded into two or more quality levels, where the different quality levels require different amounts of bandwidth or processing power to receive and decode. In these applications, a device receiving a stream may be switched from one encoding to another encoding due to changes in available processing power or available bandwidth. However, predictively-coded streaming video depends on a reference for decoding, which may cause a prediction error if a user switches from one encoding to another. This creates a demand for video streaming which can dynamically switch from one stream to another without or with reduced prediction error. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for dynamic switching in coded bitstreams. Some embodiments are particularly directed to techniques for determining a timepoint to switch from broadcasting a first video stream to broadcasting a second video stream. In one embodiment, for example, an apparatus may comprise a switching component operative to determine a timepoint to switch from broadcasting a first video stream to broadcasting a second video stream. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system for video broadcast with dynamic switching.

FIG. 2 illustrates an embodiment of a logic flow for the system of FIG. 1.

FIG. 3 illustrates an embodiment of a centralized system for the system of FIG. 1.

FIG. 4 illustrates an embodiment of a distributed system for the system of FIG. 1.

FIG. 5 illustrates an embodiment of a computing architecture.

FIG. 6 illustrates an embodiment of a communications architecture.

### DETAILED DESCRIPTION

Various embodiments are directed to techniques for dynamic switching in coded bitstreams. Streaming video is the transmission and reception of a video stream where playback of the video stream is possible before the complete stream has downloaded. In some embodiments, streaming video may allow for the playback of a video stream almost instantly, such as once a buffer has been sufficiently filled with buffered frames.

Streaming video may be appropriate to a number of different applications. Some applications may stream already-encoded video while others may stream video that is being encoded at substantially the same time as transmission. Video-on-demand services make use of streaming video in order to more immediately satisfy user demands for a particular video. Live video applications, such as the streaming of live events such as sports, entertainment, or news, may use streaming video in order to satisfy a demand for live coverage of an event. Conferencing applications, such as a group conference or a one-on-one video chat, may use streaming video in order to allow a live, natural back-and-forth between members of the conference or chat.

Because streaming video may be played as it is received, it is limited by the ability of transmitting network to deliver the bitstream comprising the streaming video. As such, the quality of a video stream may be limited by the available bandwidth between a video broadcaster and a video receiver. A bitstream may refer to a sequence of bits, the bits comprising an encoding of the video. A video stream may be at a particular level of quality. A level of quality may refer to any measurement of the visual quality of a video stream. In various embodiments, a level of quality may refer to a bitrate of a video stream, a format used to encode a video stream, a level of distortion in a video stream, or any combination of these or other quality factors.

In some embodiments, a video source may be encoded into multiple video streams. These different video streams may have different levels of quality and may use different amounts of bandwidth for transmission. Because of device or network limitations or user preferences video streams of differing quality level may be transmitted to different devices, or a certain device may require or request a stream of a certain quality level, or may require or request a stream of no more than a specified quality level. Some receiving devices may be limited in the amount of bandwidth available to them to receive a video stream, and as such may be limited in the quality of the video streams they can receive. Some receiving devices may be limited in the amount of processing resources available to them to decode a video stream, and as such may be limited in the quality of the video streams they can receive. Other limitations on received video quality may exist as well. While for some devices and some network configurations these limitations may be constant, such that a stream of appropriate quality may be determined prior to transmission, for some devices and network configurations these limitations may be variable or may be difficult to predict, such that an ability to dynamically adjust the quality level of a received stream is desirable.

In various standards for video encoding, such as the H.264 standard for video compression (alternatively referred to as MPEG-4 Part 10 or the Advanced Video Coding (AVC) standard) different types of frame encodings may be used. In video encoding, an intra frame may refer to a frame of video data encoded using only predictive references to the video data belonging to the current frame, as well as the various constants and variables which inform the encoding scheme, without reference to the video data of any other frame. A frame encoded as an intra frame may be said to have been encoded using intra prediction by an encoder operating in intra mode. An inter frame may refer to a frame of video data encoded with reference to the video data belonging to frames other than the current one, in addition to the various constants and variables which inform the encoding scheme. A frame encoded as an inter frame may be said to have been encoded using inter prediction by an encoder operating in inter mode. In particular, in the H.264 standard there are I-frames encoded using intra prediction, P-frames encoded using inter prediction referencing at most one other frame, and B-frames referencing at most two other frames. Therefore, in the H.264 standard, I-frames are encoded in the intra mode while P-frames and B-frames are encoded in the inter mode.

In some embodiments, a stream may be encoded using a flat predictive structure. In some embodiments, a stream may comprise a sequence of frames. In a flat predictive structure, the sequence of frames is encoded such that each frame references, or depends on, only the immediately previous frame in the sequence. To illustrate, if a sequence of P-frames is {P₁, P₂, P₃, P₄, P₅, . . . }, then the decoding of each frame Pₙ, depends on, at most, the decoded data of frame Pₙ₋₁. As described above, in any encoding structure, a P-frame depends on at most one previous frame in the sequence. In a flat predictive structure, the frame depends on only the immediately previous frame in the sequence, without depending on any frame besides the immediately previous frame. In various embodiments, the frame from which a frame depends may be referred to as a parent frame. The parent frame of a current frame is the frame from which current frame depends; the encoding of a P-frame references the video data of at most one other frame, which frame is the parent frame. In various embodiments, the ancestors of a current frame are the current frame's parent frame and the ancestors of the parent frame. In a flat prediction structure, the ancestors of a given frame are the entire preceding sequence of frames in the video stream.

In some embodiments, a stream may be encoded using a hierarchical predictive structure. In a hierarchical predictive structure the sequence of frames is encoded such that every frame depends from either the immediately previous frame in the sequence or an ancestor of the immediately previous frame in the sequence. A hierarchical predictive structure may be composed of two types of frames: primary frames and secondary frames. Primary frames may be those frames which are either the first frame in the sequence of frames or a frame which is the last frame in the sequence of frames to depend on a particular primary frame. A secondary frame may be all other frames, and as such may be those frames which depend from another secondary frame or which depends from a primary frame but are not the last frame in the sequence to depend from that primary frame.

In some embodiments, a hierarchical predictive structure may be organized such that a primary frame occurs at regular intervals. This interval may be measured in the number of frames comprising the interval. For example, if every third frame is a primary frame, then the interval size would be three. Each interval may define a group of frames. A group of frames may comprise a set of frames, a portion of the sequence of frames, beginning with a primary frame. A group of frames may have a size equal to the number of frames in the group, equal to the size of the interval described above. In some embodiments, a group of frames may comprise a primary frame followed by a sequence of secondary frames, the secondary frames all depending from the primary frame or another member of the group of frames. In various embodiments, a video stream may be encoded using groups of frames, where each group of frames is of the same size. In various embodiments, two different encodings of the same video source may use two different sizes for their corresponding groups of frames.

In some embodiments, a video broadcaster may be able to dynamically adjust a stream that it is broadcasting in order to vary the amount of bandwidth the stream uses. In various embodiments, this ability to dynamically adjust may be empowered by the use of a hierarchical predictive structure utilizing groups of frames of a regular size. As described above, in a hierarchical predictive structure, some secondary frames will have no frames which depend from them. A frame from which no frame depends may be referred to as a childless frame. In various embodiments, in order to conserve transmission bandwidth, a video broadcasting system may drop (i.e. refrain from broadcasting) one or more childless frames. This may reduce the perceived visual quality of the transmission, as the effective frame rate would be lowered. However, as no frames depend on these childless frames, predictive decoding may proceed unhindered despite the dropped frame. Further, dropping one childless frame may create a pseudo-childless frame in the parent frame if no other frame depends from that parent. A pseudo-childless frame may be a frame where all frames which depend from that frame, if any, have been dropped. In various embodiments, a group of frames may comprise exactly one primary frame, with the rest of the group composed of secondary frames. In this case, the group of frames may be reduced by dropping childless or pseudo-childless frames until only one frame, the primary frame, remains to be broadcast, with all of the secondary frames dropped. It will be appreciated that if a group of frames comprises exactly one primary frame that any number of frames between one and the size of the group may be broadcast while still allowing for the proper prediction of all broadcast frames. As such, considerable flexibility may be realized by using a hierarchical predictive structure.

As previously stated, in some embodiments, a video source may be encoded into multiple video streams. These different video streams may have different levels of quality and may use different amounts of bandwidth for transmission. In various embodiments, a particular stream may be selected for a particular client device on the basis of available bandwidth and processing resources. In various embodiments, one or more of the multiple video streams for the same video source may be encoded using a hierarchical predictive structure. As described above, this may allow for the dynamic adjustment of bandwidth usage in transmission of the video stream. However, some methods of managing bandwidth or processing resources usage, such as changing the resolution of the video stream, may not be empowered by the hierarchical predictive structure. Similarly, some methods of managing memory usage, such as changing the size of a group of frames, may not be empowered by the hierarchical predictive structure. As such, despite the use of a hierarchical predictive structure, further methods of managing bandwidth, processing, and memory usage may be desirable. As such, if multiple video streams for the same video source are available, it may be desirable to be able to dynamically switch between the video streams in order to switch to a video stream that maximizes the visual quality of the video stream within the bandwidth, processing, and memory limitations of the network or client device.

However, switching between video streams may be complicated, particularly when a hierarchical predictive structure is used. If a flat predictive structure is used, each frame depends from the immediately previous frame. In some embodiments, if a first stream and a second stream are each encodings of the same video source, then some frames of each sequence of frames that comprise the streams will correspond to an encoding of the same source frame from the video source. For example, if the video source comprises frames {R₁, R₂, R₃, R₄, R₅, . . . } and the first stream comprises frames {P₁, P₂, P₃, P₄, P₅, . . . } and the second stream comprises frames {Q₁, Q₂, Q₃, Q₄, Q₅, . . . }, then Pₙ and Qₙ may each comprise a different encoding of the source frame Rₙ. In some embodiments, therefore, a switch from the first stream to the second stream may be carried out at time 3 by broadcasting the sequence {P₁, P₂, Q₃, Q₄, Q₅, . . . }. While Q₃ was originally predicted using frame Q₂, frame P₂, by virtue of being based on the same source frame R₂, is likely to be substantially similar to frame Q₂. As such, the output frame created by combining the Q₃ prediction information with the decoded frame P₂ is likely to be substantially similar to the output frame that would have been created had the Q₃ prediction information been combined with a decoded frame Q₂. The above examples may represent a situation in which both the first and second stream are encoded at the same frame rate as the video source. In some embodiments, one or both of the first and second video stream may be encoded at a different frame rate than the video source. In some instances, the lower quality stream may be encoded at a lower frame rate in order to conserve bandwidth. In that instance, some frames in the first stream may not have corresponding frames in the second stream encoded from the same source frame.

When a hierarchical predictive structure is used, however, it may be beneficial to select an appropriate timepoint to make a switch. If a hierarchical predictive structure is used, two frames from different streams may be encodings of the same source frame while depending on different parent frames. To modify the example above, if frame P₃ depends from frame P₂ while frame Q₃ depends from frame Q₁, then the broadcast sequence {P₁, P₂, Q₃, Q₄, Q₅, . . . } may drift substantially from the video source as frame P₁ may no longer be available for Q₃ to reference as the video decoder may have discarded its video data. While video decoders may be configured to buffer all frames which will be referenced by future frames, it may be impractical to require a video decoder to buffer all frames which are not only reference by future frames in the current video stream, but which may be used as a reference in all possible video streams to which the video decoder might switch.

As such, in various embodiments, a timepoint for switching may be determined by determining the next upcoming frame in the second stream that is a primary frame that is also encoded as a reference frame in the first stream. For example, to modify the example above, suppose that frame Q₃ is a primary frame in the second stream and frame P₃ is available for reference by frame P₄. In that case, if the sequence {P₁, P₂, P₃, Q₄, Q₅, . . . } were transmitted, then we know that each of frames {Q₄, Q₅, Q₆, . . . } depend from frame Q₃ or a later frame in the sequence. As such, every frame will have an appropriate reference frame, the frame from which it depends, buffered as per the normal decoding process, though any frame depending on frame Q₃ will have to use frame P₃. As such, in various embodiments, a video broadcast system may switch from a first stream to a second stream at a timepoint such that the last frame broadcast from the first stream is available for reference by a later frame and is an encoding of a frame from the video source that is encoded as a primary frame in the second stream. As such, in various embodiments, the timepoints of primary frames in the second stream that are also encoded in the first stream may comprise a set of valid switching timepoints. If the first and second streams are encoded at the same frame rate and with the same predictive structure, this may comprise all of the primary frames in the second stream. If the first and second stream are encoded at a different frame rate or/and with a different predictive structure, this may comprise all of the primary frames in the second stream that are encoded from a source frame also encoded as a reference frame in the first video stream, a source frame being a frame from the source video.

As stated above, a switch from a first stream to a second stream may involve some frames encoded with reference to frames from the second stream being decoded with reference to frames from the first stream. As such, while this decoding may be similar to decoding using the intended reference frames, it may not be identical, causing visual artifacts. In various embodiments, these artifacts may be reduced or eliminated using known techniques for addressing drift. For example, in various embodiments, these artifacts may be reduced or eliminated through a request for an I-frame. In various embodiments, switching frames may be used. Switching frames may comprise a set of frames specifically encoded to allow switching from one video stream to another without drift or visual artifacts. Switching frames may be specific to a switch from one specific stream to another specific stream. To continue the above example, video stream {P₁, P₂, P₃, P₄, P₅, . . . } and video stream {Q₁, Q₂, Q₃, Q₄, Q₅, . . . } may have associated with them {S₁, S₄, S₇, . . . } where Sₙ is a switching frame that encodes a source frame Rₙ. Times 1, 4, and 7 may correspond to the valid switching timepoints described previously, such that {Q₁, Q₄, Q₇, . . . } are primary frames in the second stream encoded from source frames also encoded in the first stream. As such, a switch from the first stream to the second stream may be timed for time 4, producing the broadcast sequence {P₁, P₂, P₃, S₄, Q₅, . . . }.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

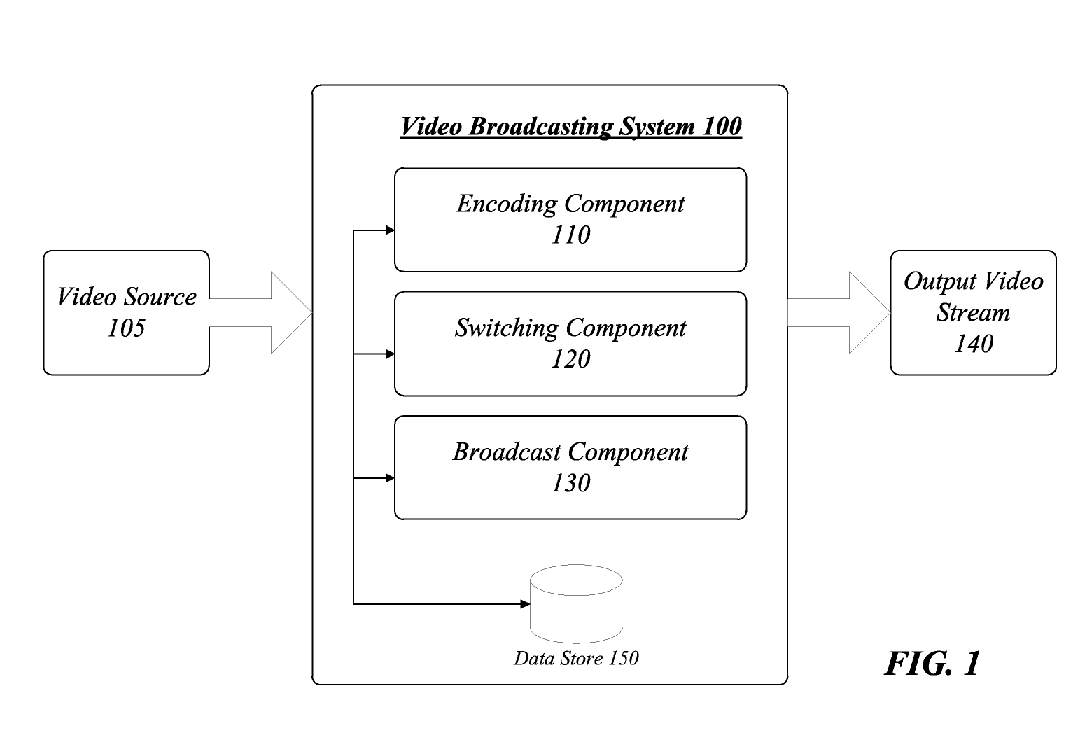

FIG. 1 illustrates a block diagram for a video broadcasting system 100.

In one embodiment, the video broadcasting system 100 may comprise a computer-implemented video broadcasting system 100 having one or more software applications and/or components. Although the system video broadcasting system 100 shown in FIG. 1 has a limited number of elements in a certain topology, it may be appreciated that the video broadcasting system 100 may include more or less elements in alternate topologies as desired for a given implementation.

In the illustrated embodiment shown in FIG. 1, the video broadcasting system 100 includes an encoding component 110, a switching component 120, a broadcast component 130, and a data store 150. The encoding component 110 is generally operative to encode a video source 105 into a first video stream at a first quality level and a second video stream at a second quality level. The switching component 120 is generally operative to determine a timepoint to switch from broadcasting the first video stream to broadcasting the second video stream. The broadcast component 130 is generally operative to broadcast an output video stream 140.

In various embodiments, one or more of the components may be embodied in a centralized system. For instance, the encoding component 110, the switching component 120, the broadcast component 130, and the data store 150 may all be implemented in a single computing entity, such as entirely within a single computing device. In various embodiments, one or more of the component may be embodied in a distributed system. For instance, the encoding component 110, the switching component 120, and the broadcast component 130 may each be implemented across different computing entities, such that each is within different computing devices. In other instances, the encoding component 110 may be implemented in a first computing entity and the switching component 120 and the broadcast component 130 may be implemented together in a second computing entity.

In various embodiments, the encoding component 110 is generally operative to encode a video source 105 into a first video stream at a first quality level and a second video stream at a second quality level. In various embodiments, the first and second video streams may be part of a plurality of streams encoded at different quality levels. The encoding component 110 may be operative to encode the video source 105 according to any appropriate known video encoding standard, such as the H.264 video encoding standard. The first video stream may comprise a first set of primary frames. The second video stream may comprise a second set of primary frames. In various embodiments, a primary frame may be a frame such that no later frames in the associated video stream will depend from or reference a frame in the video stream previous to the primary frame.

In various embodiments, the encoding component 110 may be operative to encoding the first and second video streams in a hierarchical predictive structure. The first video stream may comprise a first hierarchical predictive structure and the second video stream may comprise a second hierarchical predictive structure. The first hierarchical predictive structure may comprise a first set of primary frames and a first set of secondary frames. The second hierarchical predictive structure may comprise a second set of primary frames and a second set of secondary frames. The first video stream may be divided into first groups of frames of a first size. The second video stream may be divided into second groups of frames of a second size. The size of a group of frames may correspond to the number of frames in the group. Each group of frames may comprise exactly one primary frame and a plurality of secondary frames. As such, the size of a group of frames may be one greater than the number of secondary frames in the group of frames. The first video stream may have a first frame rate. The second video stream may have a second frame rate. A frame rate may correspond to a number of frames per second in an encoded video stream.

In various embodiments, the encoding component 110 may be operative to encode a set of switching frames. The encoding component 110 may be operative to encode a set of switching frames specific to a pair of encoded video streams such as the first video stream and the second video stream. The encoding component 110 may be operative to encode a set of switching frames specific to all pairs of encoded video streams. In various embodiments, a switching frames may be encoded for all valid switching timepoints. In various embodiments, switching frames may be encoded only for valid switching timepoints.

In various embodiments, the switching component 120 is generally operative to determine a timepoint to switch from broadcasting a first video stream to broadcasting a second video stream. The first video stream and second video stream may comprise the output of the encoding component 110. The first and second video streams may comprise two out of a plurality of video streams encoded from the video source 105, with the first stream encoded at a first quality level and the second stream encoded at a second quality level.

In various embodiments, the switching component 120 is generally operative to determine the timepoint by determining a closest upcoming frame in the set of primary frames for the second video stream that is encoded from a source frame also encoded as a reference frame in the first video stream. The closest upcoming frame in the set of primary frames may correspond to the next frame in the video stream that is a primary frame. A primary frame may be a frame which is either the first frame in a sequence of frames or a frame which is the last frame in a sequence of frames to depend from or reference a particular primary frame that is encoded from a source frame also encoded in the first video stream.

In various embodiments, the switching component 120 is generally operative to determine a minimum interval between primary frames in each of the first video stream and the second video stream. The switching component 120 may be generally operative to determine the timepoint based on the minimum interval. This minimum interval may be measured in the number of frames comprising the minimum interval. This minimum interval may be measured in the length of time making up the minimum interval, such as a number of seconds or milliseconds. The switching component 120 may determine the timepoint as being the next occurrence of the start of a new minimum interval. The set of timepoints corresponding to the starts of minimum intervals may comprise a set of switching timepoints, which are the timepoints appropriate for switching from the first video stream to the second video stream.

In various embodiments, the switching component 120 is generally operative to determine the minimum interval as a maximum of a first value and a second value, the first value equal to the first frame rate of the first video stream divided by the first size of the first group of frames of the first video stream, the second value equal to the second frame rate of the second video stream divided by the second size of the second group of frames of the second video stream.

In various embodiments, the broadcast component 130 is generally operative to broadcast an output video stream 140. The sequence of frames transmitted in the broadcast video stream 140 may correspond to frames from the plurality of video streams encoded by the encoding component 110. The broadcast of the output video stream 140 may comprise broadcasting frames as they are encoded by the encoding component 110, such as in a live broadcast. The broadcast of the output video stream 140 may comprise broadcasting frames from a stored video stream or plurality of video streams, such as may be stored on data store 150.

In various embodiments, the broadcast component 130 is generally operative to broadcast frames from the first video stream before the timepoint and switch to broadcasting frames from the second video stream at the timepoint. The broadcast component 130 may switch directly from the first video stream to the second video stream when switching frames are not available, such as when the encoding format does not support switching frames or when the encoder does not produce switching frames. The broadcast component 130 may be generally operative to use intra-frame refreshes or other drift-accommodation techniques after switching directly from one video stream to another video stream without the use of switching frames.

In various embodiments, the broadcast component 130 is generally operative to broadcast frames from the first video stream before the timepoint, to broadcast a switching frame at the timepoint, and to broadcasting frames from the second video stream after the timepoint. The broadcast component 130 may preferentially use switching frames when switching frames are available. The switching frame may be selected from a sequence of switching frames. The sequence of switching frames may be specific to a pair of encoded video streams such as the first video stream and the second video stream. Sequences of switching frames specific to all pairs of encoded video streams may be available, the broadcast component 130 selecting the appropriate sequence of switching frames for the first and second video streams. The sequence of switching frames specific to the first and second video streams may consist of only switching frames corresponding to switching timepoints from the set of switching timepoints.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be needed for a novel implementation.

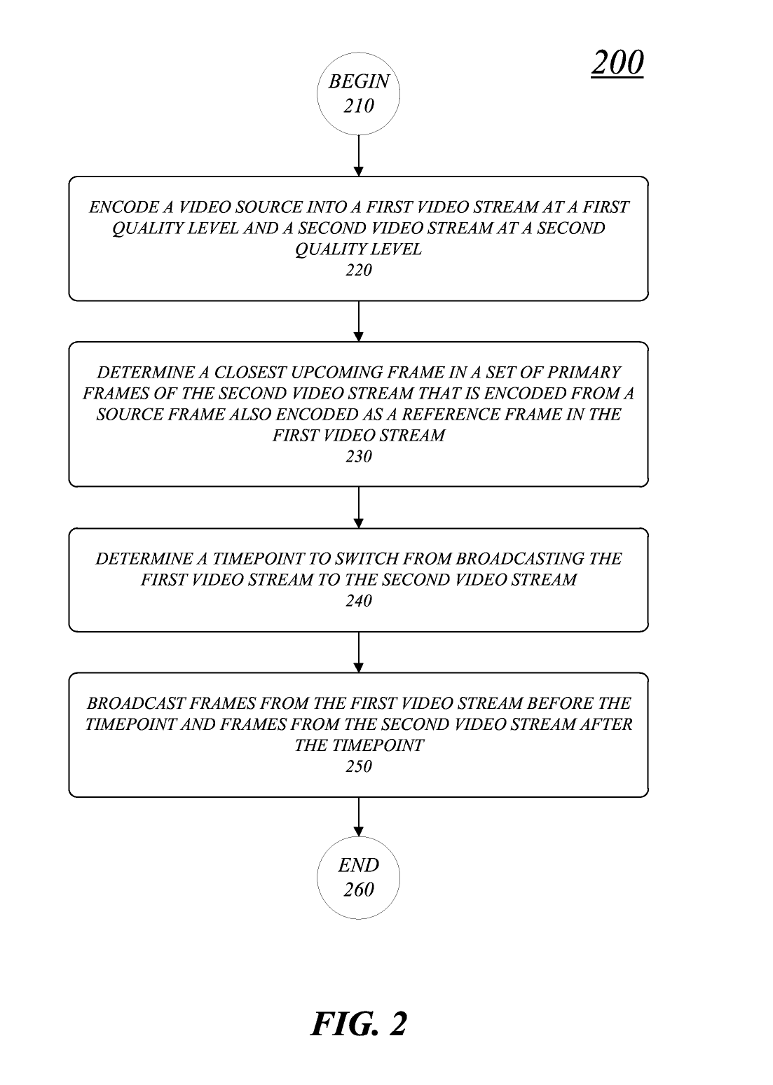

FIG. 2 illustrates one embodiment of a logic flow 200. The logic flow 200 may be representative of some or all of the operations executed by one or more embodiments described herein.

The operations recited in logic flow 200 may be embodied as computer-readable and computer-executable instructions that reside, for example, in data storage features such as a computer usable volatile memory, a computer usable non-volatile memory, and/or data storage unit. The computer-readable and computer-executable instructions may be used to control or operate in conjunction with, for example, a processor and/or processors. Although the specific operations disclosed in logic flow 200 may be embodied as such instructions, such operations are exemplary. That is, the instructions may be well suited to performing various other operations or variations of the operations recited in logic flow 200. It is appreciated that instructions embodying the operations in logic flow 200 may be performed in an order different than presented, and that not all of the operations in logic flow 200 may be performed.

In operation 210, operations for the logic flow 200 are initiated.

In operation 220, a video source is encoded into a first video stream at a first quality level and into a second video stream at a second quality level. In various embodiments, the first and second video streams may be part of a plurality of streams encoded at different quality levels. The encoding component 110 may be operative to encode the video source 105 according to any appropriate known video encoding standard, such as the H.264 video encoding standard. The first video stream may comprise a first set of primary frames. The second video stream may comprise a second set of primary frames. In various embodiments, a primary frame may be a frame such that no later frames in the associated video stream will depend from or reference a frame in the video stream previous to the primary frame.

In various embodiments, the first and second video streams may be encoded in a hierarchical predictive structure. The first video stream may comprise a first hierarchical predictive structure and the second video stream may comprise a second hierarchical predictive structure. The first hierarchical predictive structure may comprise a first set of primary frames and a first set of secondary frames. The second hierarchical predictive structure may comprise a second set of primary frames and a second set of secondary frames. The first video stream may be divided into first groups of frames of a first size. The second video stream may be divided into second groups of frames of a second size. The size of a group of frames may correspond to the number of frames in the group. Each group of frames may comprise exactly one primary frame and a plurality of secondary frames. As such, the size of a group of frames may be one greater than the number of secondary frames in the group of frames. The first video stream may have a first frame rate. The second video stream may have a second frame rate. A frame rate may correspond to a number of frames per second in an encoded video stream.

In various embodiments, a set of switching frames may be encoded. The set of switching frames may be encoded specific to a pair of encoded video streams such as the first video stream and the second video stream. A set of switching frames may be encoded specific to all pairs of encoded video streams.

In operation 230, a closest upcoming frame in a set of primary frames of the second video stream that is encoded from a source frame also encoded as a reference frame in the first video stream is determined. The closest upcoming frame in the set of primary frames may correspond to the next frame in the video stream that is a primary frame that is encoded from a source frame also encoded as a reference frame in the first video stream. A primary frame may be a frame which is either the first frame in a sequence of frames or a frame which is the last frame in a sequence of frames to depend from or reference a particular primary frame.

In operation 240, a timepoint to switch from broadcasting the first video stream to the second video stream is determined. The first and second video streams may comprise two out of a plurality of video streams encoded from the video source 105, with the first stream encoded at a first quality level and the second stream encoded at a second quality level.

In various embodiments, the timepoint may be determined as corresponding to a closest upcoming frame in the set of primary frames for the second video stream that is encoded from a source frame also encoded as a reference frame in the first video frame, such as the timepoint for broadcasting the closest upcoming frame. The closest upcoming frame in the set of primary frames may correspond to the next frame in the video stream that is a primary frame. In various embodiments, a minimum interval between primary frames in each of the first video stream and the second video stream may be determined. The timepoint may be determined based on the minimum interval. This minimum interval may be measured in the number of frames comprising the minimum interval. This minimum interval may be measured in the length of times making up the minimum interval, such as a number of seconds or milliseconds. The timepoint may be determined as being the next occurrence of the start of a new minimum interval. The set of timepoints corresponding to the starts of minimum intervals may comprise a set of switching timepoints, which are the timepoints appropriate for switching from the first video stream to the second video stream.

In various embodiments, the minimum interval may be determined as a maximum of a first value and a second value, the first value equal to the first frame rate of the first video stream divided by the first size of the first group of frames of the first video stream, the second value equal to the second frame rate of the second video stream divided by the second size of the second group of frames of the second video stream.

In operation 250, frames from the first video stream are broadcast before the timepoint and frames from the second video stream are broadcast after the timepoint. In various embodiments, a frame from the second video stream may be broadcast at the timepoint. A direct switch may be made from the first video stream to the second video stream when switching frames are not available, such as when the encoding format does not support switching frames or when the encoder does not produce switching frames. Intra-frame refreshes or other drift-accommodation techniques may be used after switching directly from one video stream to another video stream without the use of switching frames.

In various embodiments, a switching frame may be broadcast at the timepoint. Switching frames may be preferentially used when switching frames are available. The switching frame may be selected from a sequence of switching frames. The sequence of switching frames may be specific to a pair of encoded video streams such as the first video stream and the second video stream. Sequences of switching frames specific to all pairs of encoded video streams may be available, such that the appropriate sequence of switching frames is selected for the first and second video streams. The sequence of switching frames specific to the first and second video streams may consist of only switching frames corresponding to switching timepoints from the set of switching timepoints.

In operation 260, operations for the logic flow 200 are terminated.

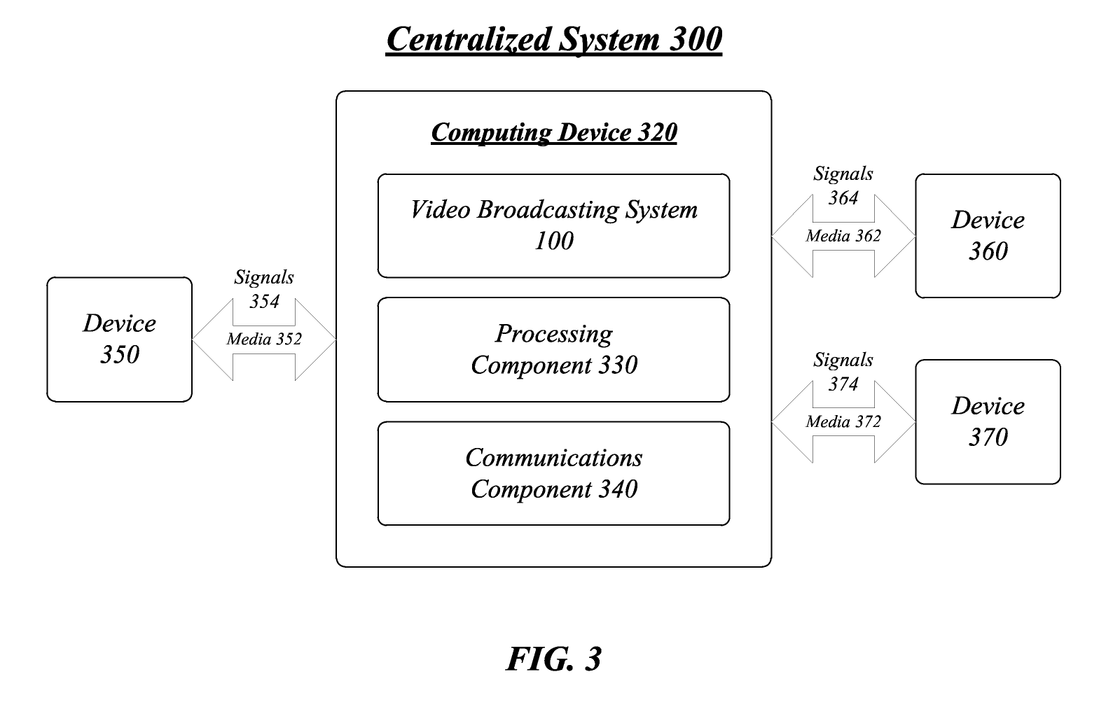

FIG. 3 illustrates a block diagram of a centralized system 300. The centralized system 300 may implement some or all of the structure and/or operations for the video broadcasting system 100 in a single computing entity, such as entirely within a single computing device 320.

The computing device 320 may execute processing operations or logic for the video broadcasting system 100 using a processing component 330. The processing component 330 may comprise various hardware elements, software elements, or a combination of both. Examples of hardware elements may include devices, logic devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 320 may execute communications operations or logic for the system 100 using communications component 340. The communications component 340 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 340 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 350, 351 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 350, 351.

The computing device 320 may communicate with other devices 350, 360, and 370 over respective communications media 353, 363, and 373 using respective communications signals 354, 364, and 374 via the communications component 340.

In various embodiments, and in reference to FIG. 1, processing component 330 may comprise all or some of encoding component 110 and switching component 120. In various embodiments, and in reference to FIG. 1, communications component 340 may comprise broadcast component 130.

In various embodiments, and in reference to FIG. 1, communications component 340 may be used to receive the video source 105. In various embodiments, and in reference to FIG. 1, communications component 340 may be used to transmit output video stream 140. In various embodiments, device 350 may correspond to a user device, server, or other video storage and transmission device providing video source 105 to the video broadcasting system 100. In various embodiments, signals 354 transmitted over media 352 may comprise the transmission of the video source 105 to the video broadcasting system 100.

In various embodiments, devices 360 and 370 may correspond to user devices, servers, or other video viewing devices receiving output video stream 140 from the video broadcasting system 100. In various embodiments, signals 364 and 374 transmitted over media 362 and 372 may comprise the transmission of output video stream 140 to one or more destination video devices. In various embodiments, communications component 340 may comprise a video server component for a video streaming service. In various embodiments, communications component 340 may be operative to stream output video stream 140 to a plurality of viewing devices.

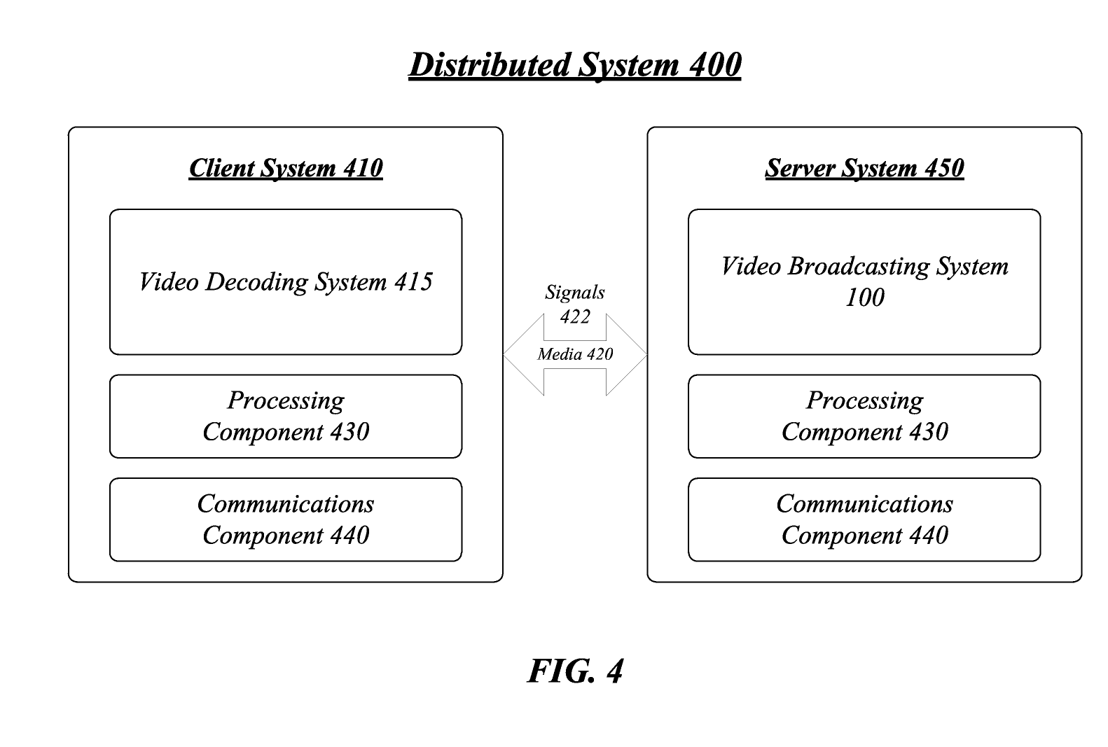

FIG. 4 illustrates a block diagram of a distributed system 400. The distributed system 400 may distribute portions of the structure and/or operations for the video broadcasting system 100 across multiple computing entities. Examples of distributed system 400 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The client system 410 and the server system 450 may process information using the processing components 430, which are similar to the processing component 330 described with reference to FIG. 3. The client system 410 and the server system 450 may communicate with each over a communications media 420 using communications signals 422 via communications components 440, which are similar to the communications component 340 described with reference to FIG. 3.

In one embodiment, for example, the distributed system 400 may be implemented as a client-server system. A client system 410 may implement the devices 360 or 370. A server system 450 may implement the encoding component 110, switching component 120, and broadcast component 130.

In various embodiments, server system 450 may comprise video broadcasting system 100. In various embodiments, processing component 430 may comprise all or some of encoding component 110, switching component 120, and broadcast component 130.

In various embodiments, the server system 450 may comprise or employ one or more server computing devices and/or server programs that operate to perform various methodologies in accordance with the described embodiments. For example, when installed and/or deployed, a server program may support one or more server roles of the server computing device for providing certain services and features. Exemplary server systems 450 may include, for example, stand-alone and enterprise-class server computers operating a server OS such as a MICROSOFT® OS, a UNIX® OS, a LINUX® OS, or other suitable server-based OS. Exemplary server programs may include, for example, communications server programs such as Microsoft® Office Communications Server (OCS) for managing incoming and outgoing messages, messaging server programs such as Microsoft® Exchange Server for providing unified messaging (UM) for e-mail, voicemail, VoIP, instant messaging (IM), group IM, enhanced presence, and audio-video conferencing, and/or other types of programs, applications, or services in accordance with the described embodiments.

In various embodiments, communications component 440 may be used to receive video source 105. In various embodiments, communications component 440 may be used to transmit output video stream 140. In various embodiments, signals 422 transmitted on media 420 may comprise output video stream 140. In various embodiments, server system 450 may comprise a video server operative to encode video source 105 according to a defined video encoding codec, such as H.264, and transmit the encoded video stream as output video stream 140 using communications component 440. In various embodiments, server system 450 may be operative to switch output video stream 140 from a first video stream to a second video stream. The switch may be in response to the server determining that a reduction in quality level is required or desirable, such as by detecting that network conditions have sufficiently deteriorated to motivate a reduction in quality, so that the second video stream is of a lower quality than the first video stream. The switch may be in response to the server determining that an increase in quality level is required or desirable, such as by detecting that network conditions have sufficiently improved to motivate an improvement in quality, so that the second video stream is of a higher quality than the first video stream.

In various embodiments, the client system 410 may comprise or employ one or more client computing devices and/or client programs that operate to perform various methodologies in accordance with the described embodiments. In various embodiments, client system 410 may comprise a video decoding system 415. In various embodiments, client system 410 may use communications component 440 to receive output video stream 140 over media 420 as signals 422. In various embodiments, video decoding system 415 may be operative to use processing component 430 to decode the received output video stream 140. In various embodiments, video decoding system may be operative to decode the received output video stream 140 according to a defined video encoding codec, such as H.264, using processing component 430. In various embodiments, client system 450 may be operative to request that output video stream 140 be switched from a first video stream to a second video stream, such as by sending a request to change quality level to the server system 450 over media 420 using signals 422. The switch may be in response to the client determining that a reduction in quality level is required or desirable, such as by detecting that network conditions have sufficiently deteriorated or that processing or memory resources have become increasingly limited to motivate a reduction in quality, so that the second video stream is of a lower quality than the first video stream. The switch may be in response to the client determining that an increase in quality level is required or desirable, such as by detecting that network conditions have sufficiently improved or that processing or memory resources have become sufficiently available to motivate an improvement in quality, so that the second video stream is of a higher quality than the first video stream.

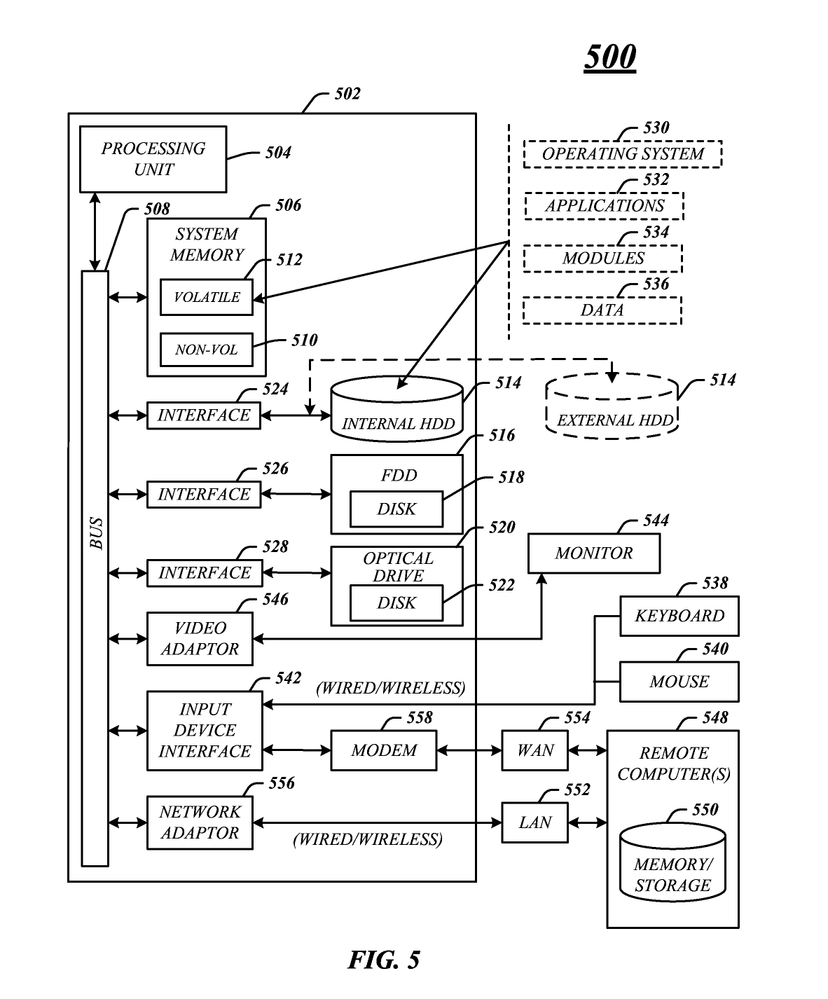

FIG. 5 illustrates an embodiment of an exemplary computing architecture 500 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 500 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 500 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 500.

As shown in FIG. 5, the computing architecture 500 comprises a processing unit 504, a system memory 506 and a system bus 508. The processing unit 504 can be any of various commercially available processors. Dual microprocessors and other multi-processor architectures may also be employed as the processing unit 504. The system bus 508 provides an interface for system components including, but not limited to, the system memory 506 to the processing unit 504. The system bus 508 can be any of several types of bus structure that may further interconnect to a memory bus (with or without a memory controller), a peripheral bus, and a local bus using any of a variety of commercially available bus architectures.

The computing architecture 500 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 5, the system memory 506 can include non-volatile memory 510 and/or volatile memory 512. A basic input/output system (BIOS) can be stored in the non-volatile memory 510.

The computer 502 may include various types of computer-readable storage media in the form of one or more lower speed memory units, including an internal hard disk drive (HDD) 514, a magnetic floppy disk drive (FDD) 516 to read from or write to a removable magnetic disk 518, and an optical disk drive 520 to read from or write to a removable optical disk 522 (e.g., a CD-ROM or DVD). The HDD 514, FDD 516 and optical disk drive 520 can be connected to the system bus 508 by a HDD interface 524, an FDD interface 526 and an optical drive interface 528, respectively. The HDD interface 524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 510, 512, including an operating system 530, one or more application programs 532, other program modules 534, and program data 536.

The one or more application programs 532, other program modules 534, and program data 536 can include, for example, the encoding component 110, switching component 120, and broadcast component 130.

A user can enter commands and information into the computer 502 through one or more wire/wireless input devices, for example, a keyboard 538 and a pointing device, such as a mouse 540. Other input devices may include a microphone, an infra-red (IR) remote control, a joystick, a game pad, a stylus pen, touch screen, or the like. These and other input devices are often connected to the processing unit 504 through an input device interface 542 that is coupled to the system bus 508, but can be connected by other interfaces such as a parallel port, IEEE 1394 serial port, a game port, a USB port, an IR interface, and so forth.

A monitor 544 or other type of display device is also connected to the system bus 508 via an interface, such as a video adaptor 546. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer 548. The remote computer 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wire/wireless connectivity to a local area network (LAN) 552 and/or larger networks, for example, a wide area network (WAN) 554. Such LAN and WAN networking environments are commonplace in offices and companies, and facilitate enterprise-wide computer networks, such as intranets, all of which may connect to a global communications network, for example, the Internet.

When used in a LAN networking environment, the computer 502 is connected to the LAN 552 through a wire and/or wireless communication network interface or adaptor 556. The adaptor 556 can facilitate wire and/or wireless communications to the LAN 552, which may also include a wireless access point disposed thereon for communicating with the wireless functionality of the adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wire and/or wireless device, connects to the system bus 508 via the input device interface 542. In a networked environment, program modules depicted relative to the computer 502, or portions thereof, can be stored in the remote memory/storage device 550. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

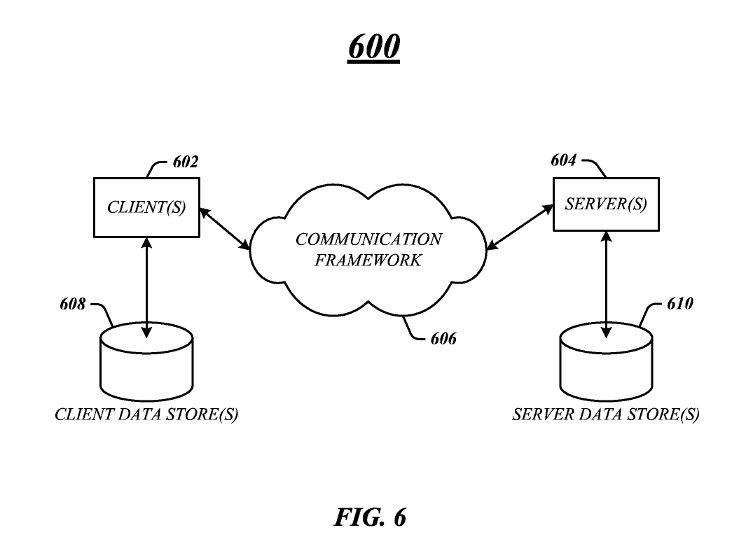

FIG. 6 illustrates a block diagram of an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, and so forth. The embodiments, however, are not limited to implementation by the communications architecture 600.

As shown in FIG. 6, the communications architecture 600 comprises includes one or more clients 602 and servers 604. The clients 602 may implement the client systems 350, 360, and 370. The servers 604 may implement the server system 450. The clients 602 and the servers 604 are operatively connected to one or more respective client data stores 608 and server data stores 610 that can be employed to store information local to the respective clients 602 and servers 604, such as cookies and/or associated contextual information.

The clients 602 and the servers 604 may communicate information between each other using a communication framework 606. The communications framework 606 may implement any well-known communications techniques and protocols, such as those described with reference to systems 100, 300, and 400. The communications framework 606 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a logic device; and
a switching component operative on the logic device to determine a timepoint to switch from broadcasting a first video stream to broadcasting a second video stream, the first video stream a first encoding of a video source at a first quality level and the second video stream a second encoding of the video source at a second quality level.

2. The apparatus of claim 1, the second video stream comprising a set of primary frames, the switching component to determine the timepoint by determining a closest upcoming frame in the set of primary frames that is encoded from a source frame also encoded as a reference frame in the first video stream.

3. The apparatus of claim 1, the first video stream comprising a first hierarchical predictive structure and the second video stream comprising a second hierarchical predictive structure, the first hierarchical predictive structure comprising a first set of primary frames, the second hierarchical predictive structure comprising a second set of primary frames.

4. The apparatus of claim 3, the switching component to determine a minimum interval between primary frames in each of the first video stream and the second video stream, the switching component to determine the timepoint based on the minimum interval.

5. The apparatus of claim 4, the first video stream divided into first groups of frames of a first size, the second video stream divided into second groups of frames of a second size, the first video stream having a first frame rate, and the second video stream having a second frame rate.

6. The apparatus of claim 5, the switching component to determine the minimum interval as a maximum of a first value and a second value, the first value equal to the first frame rate divided by the first size, the second value equal to the second frame rate divided by the second size.

7. The apparatus of claim 1, comprising a stream broadcast component operative to broadcast frames from the first video stream before the timepoint and switch to broadcasting frames from the second video stream at the timepoint.

8. The apparatus of claim 1, comprising a stream broadcast component operative to broadcast frames from the first video stream before the timepoint, to broadcast a switching frame at the timepoint, and to broadcasting frames from the second video stream after the timepoint.

9. A method, comprising:
determining a timepoint to switch from broadcasting a first video stream to a second video stream, the first video stream a first encoding of a video source at a first quality level and the second video stream a second encoding of the video source at a second quality level; and
broadcasting frames from the first video stream before the timepoint and frames from the second video stream after the timepoint.

10. The method of claim 9, comprising determining the timepoint by determining a closest upcoming frame in a set of primary frames of the second video stream that is encoded from a source frame also encoded as a reference frame in the first video stream.

11. The method of claim 9, the first video stream comprising a first hierarchical predictive structure and the second video stream comprising a second hierarchical predictive structure, the first hierarchical predictive structure comprising a first set of primary frames, the second hierarchical predictive structure comprising a second set of primary frames.

12. The method of claim 11, comprising:
determining a minimum interval between primary frames in each of the first video stream and the second video stream; and
determining the timepoint based on the minimum interval.

13. The method of claim 12, the first video stream divided into first groups of frames of a first size, the second video stream divided into second groups of frames of a second size, the first video stream having a first frame rate, and the second video stream having a second frame rate.

14. The method of claim 13, comprising determining the minimum interval as a maximum of a first value and a second value, the first value equal to the first frame rate divided by the first size, the second value equal to the second frame rate divided by the second size.

15. An article of manufacture comprising a storage medium containing instructions that when executed enable a system to:
encode a video source into a first video stream at a first quality level and a second video stream at a second quality level;
determine a timepoint to switch from broadcasting the first video stream to the second video stream; and
broadcast frames from the first video stream before the timepoint and frames from the second video stream after the timepoint.

16. The article of claim 15, comprising instructions that when executed enable a system to determine the timepoint by determining a closest upcoming frame in a set of primary frames of the second video stream that is encoded from a source frame also encoded as a reference frame in the first video stream.

17. The article of claim 15, the first video stream comprising a first hierarchical predictive structure and the second video stream comprising a second hierarchical predictive structure, the first hierarchical predictive structure comprising a first set of primary frames, the second hierarchical predictive structure comprising a second set of primary frames.

18. The article of claim 17, comprising instructions that when executed enable a system to:
determine a minimum interval between primary frames in each of the first video stream and the second video stream; and
determine the timepoint based on the minimum interval.

19. The article of claim 18, the first video stream divided into first groups of frames of a first size, the second video stream divided into second groups of frames of a second size, the first video stream having a first frame rate, and the second video stream having a second frame rate.

20. The article of claim 19, comprising instructions that when executed enable a system to determine the minimum interval as a maximum of a first value and a second value, the first value equal to the first frame rate divided by the first size, the second value equal to the second frame rate divided by the second size.
